(19) United States
(12) Patent Application Publication
(10) Pub. No.: US 2023/0245438 A1
(43) Pub. Date: Aug. 3, 2023

(54) RECOGNIZER LEARNING DEVICE, RECOGNIZER LEARNING METHOD, AND RECOGNIZER LEARNING PROGRAM

(71) Applicant: NIPPON TELEGRAPH AND TELEPHONE CORPORATION, Tokyo (JP)

(72) Inventors: Kazuhiko MURASAKI, Tokyo (JP); Shingo ANDO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/012,137

(22) PCT Filed: Jun. 22, 2020
(86) PCT No.: PCT/JP2020/024412

§ 371 Date: Dec. 21, 2022

(51) Int. Cl. G06V 10/82

(52) U.S. Cl. CPC G06V 10/82

(57) ABSTRACT

A training unit 24 performs leaning of a recognizer that recognizes labels of data based on a plurality of training data to which training labels are given. A score calculation unit 28 calculates a score output by the recognizer for each of the plurality of training data by using the trained recognizer. A threshold value determination unit 30 determines a threshold value for the score for determining the label, based on a shape of an ROC curve representing a correspondence between a true positive rate and a false positive rate, which is obtained based on the score calculated for each of the plurality of training data. A selection unit 32 selects the training data difficult to recognize by the recognizer based on the threshold value determined and the score calculated for each of the plurality of training data. The process of each unit described above is repeated until a predetermined iteration termination condition is satisfied.

### TECHNICAL FIELD

The techniques of the present disclosure relate to a recognizer training apparatus, a recognizer training method, and a recognizer training program.

### BACKGROUND ART

As a technique for automatically recognizing the meanings from digital data such as images and speeches, numerous methods using a machine training approach have been devised. In recent years, it is known that training of a recognizer by deep learning indicates high performance even for complicated data. The training of the recognizer by deep learning is performed such that a specific loss function is minimized for the output of the recognizer. The cross-entropy error function is a frequently used loss function for category identification. It is known that training proceeds efficiently by the cross-entropy error function, and it is widely used because it can be easily extended with respect to an increase in the number of categories. However, in a case where the number of data included in each target category is biased, training is made such that the identification result is biased to the category with a large number of data. Thus, the cross-entropy error function is an inappropriate loss function in a case where it is desired to emphasize the recognition accuracy of a category with a small number of data in practice. As a loss function used in such a case, the Area Under the Curve (AUC) in the Receiver Operating Characteristic (ROC) curve can be used. The ROC curve is a curve that plots the correspondence between the True Positive Rate (TPR) and the False Positive Rate (FPR). By maximizing the AUC, which is the area formed by the curve, it is possible to perform training of a well-balanced recognizer even for a category with a small number of data.

However, it is not possible to directly maximize the AUC by using deep learning, which is expected to have high recognition performance. The AUC is calculated based on the magnitude relationship of an identification score of data relative to a certain threshold, and thus an approach of advancing training to correct the magnitude relationship by using a pair of randomly selected positive and negative examples is used (NPLs 1 and 2).

### CITATION LIST

### Non Patent Literature

NPL 1: Ueda, Naonori, and Akinori Fujino. “Partial AUC Maximization via Nonlinear Scoring Functions.” arXiv preprint arXiv:1806.04838 (2018).

NPL 2: Sakai, Tomoya, Gang Niu, and Masashi Sugiyama. “Semi-supervised AUC optimization based on positive-unlabeled training.” Machine Training 107.4 (2018):767-794.

### SUMMARY OF THE INVENTION

### Technical Problem

In the techniques of NPLs 1 and 2, the training effect differs depending on the pair used for the training, and thus there is a problem that training takes time in a case where the pair is randomly selected.

The disclosed techniques have been made in light of the foregoing, and an object thereof is to provide a recognizer training apparatus, a recognizer training method, and a recognizer training program capable of efficiently training a recognizer.

### Means for Solving the Problem

A first aspect of the present disclosure is a recognizer training apparatus including: a training unit configured to perform training of a recognizer that recognizes a label of data based on a plurality of training data given a training label;
a score calculation unit configured to calculate a score output by the recognizer for each of the plurality of training data by using the recognizer leaned;
a threshold value determination unit configured to determine a threshold value for the score for determining the label, based on a shape of a Receiver Operating Characteristics (ROC) curve representing a correspondence between a true positive rate and a false positive rate, which is obtained based on the score calculated for each of the plurality of training data; and
a selection unit configured to select the training data difficult to recognize by the recognizer based on the threshold value determined and the score calculated for each of the plurality of training data,
wherein training by the training unit, calculation by the score calculation unit, determination by the threshold value determination unit, and selection by the selection unit are repeated until a predetermined iteration termination condition is satisfied, and
the training unit performs training of the recognizer based on the training data according to a selection result of the training data by the selection unit.

A second aspect of the present disclosure is a recognizer training method including: training a recognizer that recognizes a label of data based on a plurality of training data given a training label by a training unit;
calculating a score output by the recognizer for each of the plurality of training data by using the recognizer leaned by a score calculation unit;
determining a threshold value for the score for determining the label, based on a shape of a Receiver Operating Characteristics (ROC) curve representing a correspondence between a true positive rate and a false positive rate, which is obtained based on the score calculated for each of the plurality of training data by a threshold value determination unit; and
selecting the training data difficult to recognize by the recognizer based on the threshold value determined and the score calculated for each of the plurality of training data by a selection unit wherein the training, the calculating, the determining, and the selecting are repeated until a predetermined iteration termination condition is satisfied, and
the training by the training unit performs training of the recognizer based on the training data according to a selection result of the training data by the selection unit.

A third aspect of the present disclosure is a recognizer training program for causing a computer to perform:
training a recognizer that recognizes a label of data based on a plurality of training data given a training label;
calculating a score output by the recognizer for each of the plurality of training data by using the recognizer leaned;
determining a threshold value for the score for determining the label, based on a shape of a Receiver Operating Characteristics (ROC) curve representing a correspondence between a true positive rate and a false positive rate, which is obtained based on the score calculated for each of the plurality of training data; and
selecting the training data difficult to recognize by the recognizer based on the threshold value determined and the score calculated for each of the plurality of training data wherein the training, the calculating, the determining, and the selecting are repeated until a predetermined iteration termination condition is satisfied, and
the training performs training of the recognizer based on the training data according to a selection result of the training data.

### Effects of the Invention

According to the disclosed techniques, it is possible to efficiently perform training of the recognizer.

### BRIEF DESCRIPTION OF DRAWINGS

FIG. 1 is a diagram illustrating an example of an ROC curve.

FIG. 2 is a schematic block diagram of an example of a computer that functions as a recognizer training apparatus according to the present embodiment.

FIG. 3 is a block diagram illustrating a functional configuration of the recognizer training apparatus according to the present embodiment.

FIG. 4 is a flowchart illustrating the flow of the recognizer training process according to the present embodiment.

### DESCRIPTION OF EMBODIMENTS

Hereinafter, an example of embodiments of the disclosed techniques will be described with reference to the drawings. Note that, in the drawings, the same reference signs are used for the same or equivalent components and parts. The dimensional ratios in the drawings may be exaggerated for convenience of explanation and may differ from actual ratios.

### Overview of Present Embodiment

In the present embodiment, for efficient AUC maximization training, training data having high training effects are adaptively selected according to the training situation of the recognizer. Setting of training data difficult to recognize and selection of a training pair based on the setting are performed such that training data that are easily erroneously recognized by the recognizer during training are regarded as training data that have high training effects and are difficult to recognize. A threshold value for determining a label is determined from the shape of the ROC curve, and training data that are erroneously recognized by the determined threshold value are selected as training data difficult to recognize. The training pair is constructed centered on the training data difficult to recognize, and thus efficient training is achieved.

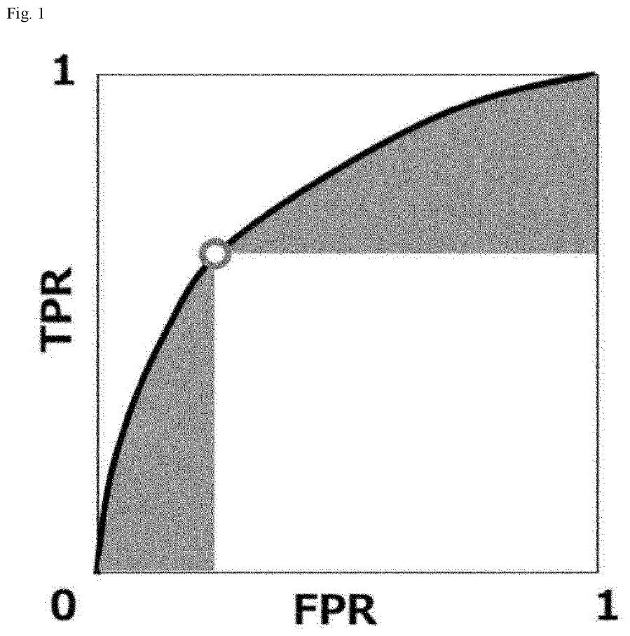

FIG. 1 illustrates a conceptual diagram of a method for determining a threshold value in the present embodiment. When the ROC curve as illustrated in FIG. 1 is obtained as the recognition performance for the training data, the point indicated by the circle obtained at the upper left corner on the ROC curve is adopted as the threshold value for selecting training data difficult to recognize. A positive example in which the score output by the recognizer is equal to or less than the threshold value and a negative example in which the score output by the recognizer is greater than the threshold value are selected as the training data difficult to recognize. Note that FIG. 1 illustrates an example illustrating an ROC curve in a graph in which the vertical axis represents TPR and the horizontal axis represents FPR. The gray portions indicate the AUC.

### Configuration of Recognizer Training Apparatus According to the Present Embodiment

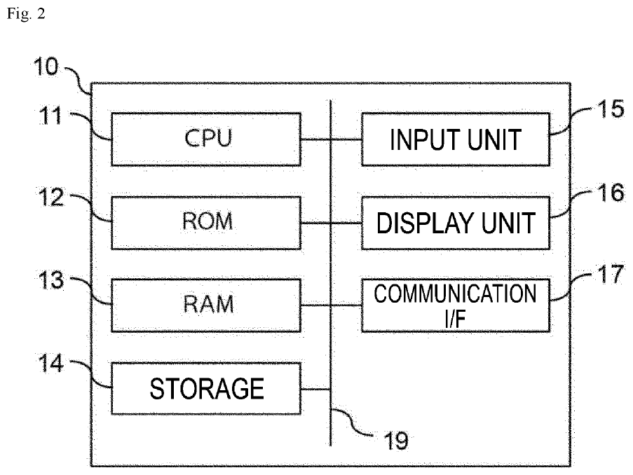

FIG. 2 is a block diagram illustrating a hardware configuration of a recognizer training apparatus 10 according to the present embodiment.

As illustrated in FIG. 2, the recognizer training apparatus 10 includes a Central Processing Unit (CPU) 11, a Read Only Memory (ROM) 12, a Random Access Memory (RAM) 13, a storage 14, an input unit 15, a display unit 16, and a communication interface (I/F) 17. The components are communicatively interconnected through a bus 19.

The CPU 11 is a central processing unit that executes various programs and controls each unit. In other words, the CPU 11 reads a program from the ROM 12 or the storage 14 and executes the program by using the RAM 13 as a work area. The CPU 11 controls each of the above-described components and various arithmetic processing operations in accordance with programs stored in the ROM 12 or the storage 14. In the present embodiment, the ROM 12 or the storage 14 stores a recognizer training program for training the recognizer. The recognizer training program may be one program, or may be a program group composed of a plurality of programs or modules.

The ROM 12 stores various programs and various kinds of data. The RAM 13 serves as a work area and temporarily stores programs or data. The storage 14 is constituted by a Hard Disk Drive (HDD) or a Solid State Drive (SSD), and stores various programs including an operating system and various kinds of data.

The input unit 15 includes a pointing device such as a mouse and a keyboard and is used for performing various inputs.

The input unit 15 receives input of a plurality of training data to which training labels are given. Here, training data is a multivariate digital signal that is integrated into a certain size such as an image or speech. A training label is a positive or negative label associated with each data. In the present embodiment, a case in which the trained recognizer outputs a score indicating a positive or negative recognition result with respect to an input digital signal will be described as an example.

The display unit 16 is, for example, a liquid crystal display and displays various kinds of information. The display unit 16 may adopt a touch panel scheme and function as the input unit 15.

The communication interface 17 is an interface for communicating with other devices and uses standards such as, for example, Ethernet (trade name), FDDI, and Wi-Fi (trade name).

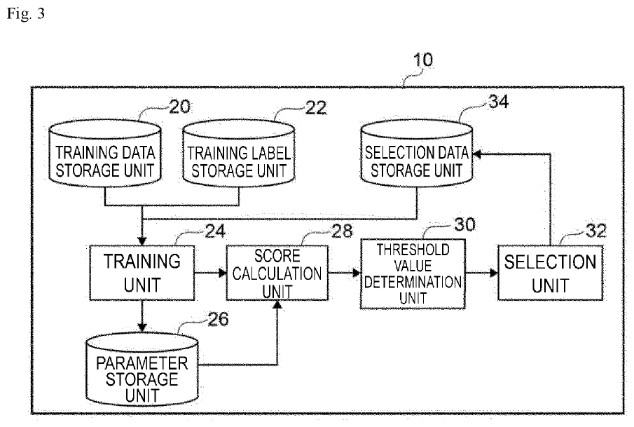

Next, the functional configuration of the recognizer training apparatus 10 will be described. FIG. 3 is a block diagram illustrating an example of the functional configuration of the recognizer training apparatus 10.

The recognizer training apparatus 10 functionally includes a training data storage unit 20, a training label storage unit 22, a training unit 24, a parameter storage unit 26, a score calculation unit 28, a threshold value determination unit 30, a selection unit 32, and a selection data storage unit 34, as illustrated in FIG. 3.

The training data storage unit 20 stores a plurality of input training data.

The training label storage unit 22 stores training labels given to each of the plurality of input training data.

The training unit 24 trains the parameters of the recognizer that recognizes the labels of the data so as to maximize the AUC based on the plurality of training data to which the training labels are given, and stores the parameters in the parameter storage unit 26. At this time, the training unit 24 performs training of the recognizer to optimize an objective function represented by using results of comparing a recognition result by the recognizer for training data difficult to recognize, and a recognition result by the recognizer for training data that are not the training data difficult to recognize and that are given training labels different from the training labels of the training data, based on the training data according to the selection result of the training data difficult to recognize by the selection unit 32 described later.

Specifically, the training unit 24 performs training of the recognizer so as to maximize the AUC by minimizing the objective function by using the training data, the training labels, and the selection result of the training data difficult to recognize. In the present embodiment, it is assumed that the recognizer is constructed by a Deep Neural Network (DNN), and a case where the parameters of the DNN are trained by backpropagation under an appropriate objective function will be described as an example. The following E is used as the objective function to be minimized.

$$[ Math . 1 ]$$

$$E = L ( {P}_{h} , {N}_{e} ) + L ( {P}_{e} , {N}_{h} ) + L ( {P}_{h} , {N}_{h} ) \qquad ( 1 )$$

$$[ Math . 2 ]$$

$$L ( P , N ) = \frac{1}{m ( P ) m ( N )} {\sum }_{{x}_{p} ∈ P} {\sum }_{{x}_{n} ∈ N} l ( f ( {x}_{p} ) - f ( {x}_{n} ) ) \qquad ( 2 )$$

Here, L(P, N) indicates a loss function calculated from a set P of positive example data that are training data to which positive labels are given as training labels and a set N of negative example data that are training data to which negative labels are given as training labels. f(x) indicates the output value of the DNN with respect to the input data x, and l(·) sets a function that gives a loss to 0 or a negative value. For example, l(z)=(l−z)² used in above-described NPL 2 can be used, but other functions may be used. xₚ and xₙ indicate positive example data and negative example data, respectively. m(·) indicates the total number of data included in the set. This objective function is a function whose value is smaller when f(xₚ) is larger than f(xₙ), and is trained such that the output of the DNN is high for positive example data and low for negative example data. The sets Pₕ and Nₕ indicate positive example data and negative example data of training data difficult to recognize, respectively, and Pₑ and Nₑ indicate positive example data and negative example data that are not training data difficult to recognize. Training is made more efficient by avoiding a comparison between Pₑ and Nₑ, which are easy for the recognizer to distinguish, and by performing a comparison using training data difficult to recognize. Note that, at the time of the initial training before performing the selection process of the training data difficult to recognize, the training is performed assuming that all the training data are the training data difficult to recognize. An appropriate iteration termination condition of training may be adopted. For example, when backpropagation is applied to a predetermined number of pairs and the parameters are updated, the training iteration is terminated.

The following equation may be used for the objective function E.

[Math. 3]

E=L(Pₕ, Nₑ)+L(Pₑ, Nₕ) (3)

The parameter storage unit 26 stores the parameters of the recognizer trained by the training unit 24.

The score calculation unit 28 calculates the score output by the recognizer for each of the plurality of training data by using the trained recognizer.

The threshold value determination unit 30 determines the threshold value for the score for determining the label, based on the shape of the ROC curve representing the correspondence between the true positive rate and the false positive rate, which is obtained based on the score calculated for each of the plurality of training data, and uses the threshold value as a threshold value for selecting the training data difficult to recognize.

Specifically, the threshold value determination unit 30 obtains a threshold value θ that minimizes the value of the following index A(θ). The index A(θ) indicates the L1 distance from the point (FPR, TPR)=(0, 1) to the point corresponding to the threshold value θ on the ROC curve.

$$[ Math . 4 ]$$

$$A ( θ ) = ( 1 - TPR ( θ ) ) + FPR ( θ ) \qquad ( 4 )$$

$$[ Math . 5 ]$$

$$TPR ( θ ) = \frac{1}{m ( P )} {\sum }_{x ∈ P} H ( f ( x ) - θ ) \qquad ( 5 )$$

$$[ Math . 6 ]$$

$$FPR ( θ ) = \frac{1}{m ( N )} {\sum }_{x ∈ N} H ( f ( x ) - θ ) \qquad ( 6 )$$

Here, H(x) indicates a step function that outputs 1 when x is larger than 0, and 0 otherwise. TPR indicates the True Positive Rate indicating the ratio of positive example data that are correctly determined to be positive in positive example data. FPR indicates the False Positive Rate indicating the ratio of negative example data that are erroneously determined to be positive in negative example data. The minimization of the index A used for the threshold value determination is to select a value such that the TPR and the FPR are both good, and it is considered that the minimization of the index A is suitable for selecting the training data difficult to recognize from the positive example data and the negative example data in a well-balanced manner. The threshold value θ is searched from 0 to 1, and ˜θ at which A (θ) is the smallest is used as the threshold value. The L2 distance may be used for the index A as follows.

[Math. 7]

A(θ)=(1−TPR(θ))²+(FPR(θ))² (7)

The selection unit 32 selects the training data difficult to recognize by the recognizer based on the determined threshold value and the score calculated for each of the plurality of training data, and stores the training data in the selection data storage unit 34. Further training is performed by the training unit 24 by utilizing the selection result of the training data difficult to recognize.

For the positive example data P,

the training data where

f(xₚ)≤\tilde{θ}

are set as the training data Pₕ difficult to recognize, and the rest are set as Pₑ. For the negative example data N,
the training data where

f(xₙ)>\tilde{θ}

are set as the training data Nₕ difficult to recognize, and the rest are set as Nₑ. Training is performed again by the training unit 24 by using each set Pₕ, Pₑ, Nₕ, and Nₑ of the selected training data.

The training by the training unit 24, the calculation by the score calculation unit 28, the determination by the threshold value determination unit 30, and the selection by the selection unit 32 are repeated until the predetermined iteration termination condition is satisfied, and the finally obtained parameters of the recognizer are output as the training result.

In this way, by sufficiently repeating the training by the training unit 24 and the selection of the training data difficult to recognize by the selection unit 32, it is possible to obtain the parameters of the recognizer that can accurately recognize at high speed.

The selection data storage unit 34 stores each set Pₕ, Pₑ, Nₕ, and Nₑ of the selected training data.

### Operations of Recognizer Training Apparatus According to the Present Embodiment

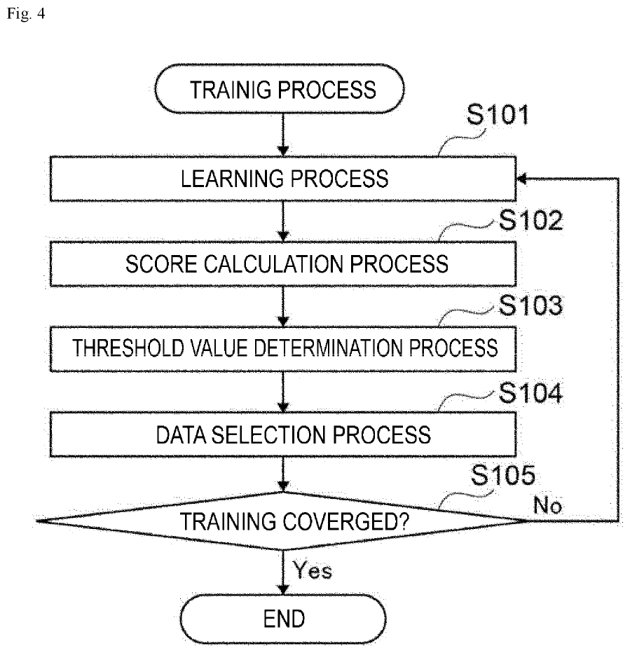

Next, the operations of the recognizer training apparatus 10 will be described. FIG. 4 is a flowchart illustrating the flow of the recognizer training process by the recognizer training apparatus 10. The recognizer training process is performed by the CPU 11 reading the recognizer training program from the ROM 12 or the storage 14, loading the recognizer training program into the RAM 13, and executing the recognizer training program. Input of a plurality of training data to which training labels are given is input to the recognizer training apparatus 10.

In step S101, the CPU 11 trains the parameters of the recognizer that recognizes the labels of the data so as to optimize the objective function based on the training data according to the selection result of the training data difficult to recognize in step S 104 described later as the training unit 24, and stores the parameters in the parameter storage unit 26.

In step S102, the CPU 11 calculates the score output by the recognizer for each of the plurality of training data by using the trained recognizer as the score calculation unit 28.

In step S103, the CPU 11 determines the threshold value for determining the score for determining the label, based on the shape of the ROC curve obtained based on the score calculated for each of the plurality of training data as the threshold value determination unit 30, and uses the threshold value as the threshold for selecting the training data difficult to recognize.

In step S104, the CPU 11 selects the training data difficult to recognize by the recognizer based on the determined threshold value and the score calculated for each of the plurality of training data as the selection unit 32, and stores the training data in the selection data storage unit 34.

In step S105, the CPU 11 determines whether or not the predetermined iteration termination condition is satisfied. In a case where the iteration termination condition is not satisfied, the process returns to step S101 described above, while in a case where the iteration termination condition is satisfied, the recognizer training process is terminated.

As described above, the recognizer training apparatus according to the present embodiment repeats training the recognizer that recognizes the labels of the data based on the training data according to the selection result of the training data, calculating the score output by the recognizer for each of the plurality of training data by using the trained recognizer, determining the threshold value based on the shape of the ROC curve obtained based on the score calculated for each of the plurality of training data, and selecting the training data difficult to recognize by the recognizer based on the determined threshold value and the score calculated for each of the plurality of training data. As a result, it is possible to perform training of the recognizer efficiently.

The AUC maximization training can be efficiently performed for problems such as equipment deterioration detection by image recognition or abnormality detection by speech recognition in which the number of occurrences of the recognition target is biased. It is expected that the time required for training will be significantly reduced by improving the efficiency of the training, and the recognition performance will be also improved.

Note that the present invention is not limited to the apparatus configurations and the operations of the above-described embodiments, and various modifications and applications are possible without departing from the scope of the present invention.

For example, in the above-described embodiments, the case where the labels to be recognized are two types of positive and negative has been described, but the present invention can be easily expanded to three or more types of labels. It is only required to set a score such that a label-likeness is output for each label, and set an objective function for each score with the target labels as positive examples and other labels as negative examples. When a set of training data of a certain label i is represented by Dⁱ and a set of other training data is represented by D\ⁱ, the objective function E for a plurality of labels is represented by the following equation.

[Math. 8]

E=Σᵢ{L(Dₕᵢⁱ, Dₑ^{\i})+L(Dₑⁱ, Dₕ^{\i})+L(Dₕⁱ, Dₕ^{\i})} (8)

Various processors other than the CPU may execute various processes executed by the CPU reading software (program) in the above-described embodiments. Examples of the processors in this case include a Programmable Logic Device (PLD) whose circuit configuration can be changed after manufacturing such as a Field-Programmable Gate Array (FPGA), a dedicated electric circuit which is a processor having a circuit configuration designed dedicatedly for executing specific processes such as an Application Specific Integrated Circuit (ASIC), and the like. The recognizer training process may be performed by one of these various processors, or may be executed by a combination of two or more processors of the same type or different types (for example, a combination of a plurality of FPGAs, a combination of a CPU and an FPGA, and the like). More specifically, the hardware structure of these various processors is an electrical circuit obtained by combining circuit devices such as semiconductor devices.

In each of the above-described embodiments, an aspect in which the recognizer training program is stored (installed) in the storage 14 in advance has been described, but the present invention is not limited thereto. The program may be provided in the form of being stored in a non-transitory storage medium such as a Compact Disk Read Only Memory (CD-ROM), a Digital Versatile Disk Read Only Memory (DVD-ROM), or a Universal Serial Bus (USB) memory. The program may be downloaded from an external device via a network.

Further, the following supplements are disclosed with respect to the above embodiments.

### Supplementary Item 1

A recognizer training apparatus including:
a memory; and
at least one processor connected to the memory,
the processor being configured to perform:
training a recognizer that recognizes a label of data based on a plurality of training data given a training label;
calculating a score output by the recognizer for each of the plurality of training data by using the recognizer leaned;
determining a threshold value for the score for determining the label, based on a shape of a Receiver Operating Characteristics (ROC) curve representing a correspondence between a true positive rate and a false positive rate, which is obtained based on the score calculated for each of the plurality of training data; and
selecting the training data difficult to recognize by the recognizer based on the threshold value determined and the score calculated for each of the plurality of training data wherein the training, the calculating, the determining, and the selecting are repeated until a predetermined iteration termination condition is satisfied, and
the training performs training of the recognizer based on the training data according to a selection result of the training data.

### Supplementary Item 2

A non-transitory storage medium storing a program executable by a computer to implement a recognizer training process,
the recognizer training process including:
training a recognizer that recognizes a label of data based on a plurality of training data given a training label;
calculating a score output by the recognizer for each of the plurality of training data by using the recognizer leaned;
determining a threshold value for the score for determining the label, based on a shape of a Receiver Operating Characteristics (ROC) curve representing a correspondence between a true positive rate and a false positive rate, which is obtained based on the score calculated for each of the plurality of training data; and
selecting the training data difficult to recognize by the recognizer based on the threshold value determined and the score calculated for each of the plurality of training data wherein the training, the calculating, the determining, and the selecting are repeated until a predetermined iteration termination condition is satisfied, and
the training performs training of the recognizer based on the training data according to a selection result of the training data.

### REFERENCE SIGNS LIST

10 Recognizer training apparatus
15 Input unit
16 Display unit
20 Training data storage unit
22 Training label storage unit
24 Training unit
26 Parameter storage unit
28 Score calculation unit
30 Threshold value determination unit
32 Selection unit
34 Selection data storage unit

1. A recognizer training apparatus comprising a processor configured to execute a method comprising:
training a recognizer that recognizes a label of data based on a plurality of training data given a training label;
calculating a score output by the recognizer for each of the plurality of training data by using the recognizer leaned;
determining a threshold value for the score for determining the label of data, based on a shape of a Receiver Operating Characteristics (ROC) curve representing a correspondence between a true positive rate and a false positive rate, which is obtained based on the score calculated for each of the plurality of training data; and
selecting the training data difficult to recognize by the recognizer based on the threshold value determined and the score calculated for each of the plurality of training data,
wherein a combination of steps including the training, the calculating, the determining, and the selecting repeats until a predetermined iteration termination condition is satisfied, and
the training further comprises training the recognizer based on the training data according to a selection result of the training data.

2. The recognizer training apparatus according to claim 1, wherein
the selecting further comprises selecting, as the training data difficult to recognize,
the training data in which the score is equal to or higher than the threshold value and the label of data recognized in a case where the score is equal to or higher than the threshold value and the training label do not match, and
the training data in which the score is less than the threshold value and the label of data recognized in a case where the score is less than the threshold value and the training label do not match.

3. The recognizer training apparatus according to claim 1, wherein
the training further comprises training the recognizer to optimize an objective function represented by using results of comparing a recognition result by the recognizer for the training data difficult to recognize, and a recognition result by the recognizer for the training data that are not the training data difficult to recognize and that are given the training label different from the training label of the training data.

4. A computer implemented method for training, comprising:
training a recognizer that recognizes a label of data based on a plurality of training data given a training label;
calculating a score output by the recognizer for each of the plurality of training data by using the recognizer;
determining a threshold value for the score for determining the label of data, based on a shape of a Receiver Operating Characteristics (ROC) curve representing a correspondence between a true positive rate and a false positive rate, which is obtained based on the score calculated for each of the plurality of training data; and
selecting the training data difficult to recognize by the recognizer based on the threshold value determined and the score calculated for each of the plurality of training data.
wherein a combination of steps including the training, the calculating, the determining, and the selecting repeats until a predetermined iteration termination condition is satisfied, and
the training further comprises training the recognizer based on the training data according to a selection result of the training data.

5. The computer implemented method according to claim 4, wherein
the selecting further comprises selecting, as the training data difficult to recognize,
the training data in which the score is equal to or higher than the threshold value and the label of data recognized in a case where the score is equal to or higher than the threshold value and the training label do not match, and
the training data in which the score is less than the threshold value and the label of data recognized in a case where the score is less than the threshold value and the training label do not match.

6. The computer implemented method according to claim 4, wherein
the training further comprises training the recognizer to optimize an objective function represented by using results of comparing a recognition result by the recognizer for the training data difficult to recognize, and a recognition result by the recognizer for the training data that are not the training data difficult to recognize and that are given the training label different from the training label of the training data.

7. A computer-readable non-transitory recording medium storing computer-executable program instructions that when executed by a processor cause a computer to execute a method comprising:
training a recognizer that recognizes a label of data based on a plurality of training data given a training label;
calculating a score output by the recognizer for each of the plurality of training data by using the recognizer leaned;
determining a threshold value for the score for determining the label of data, based on a shape of a Receiver Operating Characteristics (ROC) curve representing a correspondence between a true positive rate and a false positive rate, which is obtained based on the score calculated for each of the plurality of training data; and
selecting the training data difficult to recognize by the recognizer based on the threshold value determined and the score calculated for each of the plurality of training data,
wherein a combination of steps including the training, the calculating, the determining, and the selecting repeats until a predetermined iteration termination condition is satisfied, and
the training further comprises training the recognizer based on the training data according to a selection result of the training data.

8. The recognizer training apparatus according to claim 1, wherein the recognizer includes a deep neural network.

9. The recognizer training apparatus according to claim 1, wherein the predetermined iteration termination condition is based on a predetermined number of pairs associated with backpropagation to update one or more parameters of a deep neural networks in the recognizer for training.

10. The recognizer training apparatus according to claim 1, wherein the recognizer, based on training, recognizes image data for detecting equipment deterioration.

11. The recognizer training apparatus according to claim 1, wherein the recognizer, based on training, recognizes voice data for detecting anomaly.

12. The recognizer training apparatus according to claim 2, wherein
the training further comprises training the recognizer to optimize an objective function represented by using results of comparing a recognition result by the recognizer for the training data difficult to recognize, and a recognition result by the recognizer for the training data that are not the training data difficult to recognize and that are given the training label different from the training label of the training data.

13. The computer implemented method according to claim 4, wherein the recognizer includes a deep neural network.

14. The computer implemented method according to claim 4, wherein the predetermined iteration termination condition is based on a predetermined number of pairs associated with backpropagation to update one or more parameters of a deep neural networks in the recognizer for training.

15. The computer implemented method according to claim 4, wherein the recognizer, based on training, recognizes either image data for detecting equipment deterioration or voice data for detecting anomaly.

16. The computer-readable non-transitory recording medium according to claim 7, wherein
the selecting further comprises selecting, as the training data difficult to recognize,
the training data in which the score is equal to or higher than the threshold value and the label of data recognized in a case where the score is equal to or higher than the threshold value and the training label do not match, and
the training data in which the score is less than the threshold value and the label of data recognized in a case where the score is less than the threshold value and the training label do not match.

17. The computer-readable non-transitory recording medium according to claim 7, wherein
the training further comprises training the recognizer to optimize an objective function represented by using results of comparing a recognition result by the recognizer for the training data difficult to recognize, and a recognition result by the recognizer for the training data that are not the training data difficult to recognize and that are given the training label different from the training label of the training data.

18. The computer-readable non-transitory recording medium according to claim 7, wherein the recognizer includes a deep neural network.

19. The computer-readable non-transitory recording medium according to claim 7, wherein the predetermined iteration termination condition is based on a predetermined number of pairs associated with backpropagation to update one or more parameters of a deep neural networks in the recognizer for training.

20. The computer-readable non-transitory recording medium according to claim 7, wherein the recognizer, based on training, recognizes image data for detecting equipment deterioration or voice data for detecting anomaly.
